(19) United States
(12) Patent Application Publication
(10) Pub. No.: US 2022/0261543 A1
(43) Pub. Date: Aug. 18, 2022

(54) PROCESSING CIRCULAR REFERENCES DURING SINGLE-PASS VALIDATION OF FILES

(71) Applicant: HEWLETT PACKARD ENTERPRISE DEVELOPMENT LP, Houston, TX (US)

(72) Inventors: SHAUN WACKERLY, Houston, TX (US); UYEN CHAU, Roseville, CA (US); FRANK WOOD, Roseville, CA (US)

(21) Appl. No.: 17/175,589

(22) Filed: Feb. 12, 2021

(51) Int. Cl. G06F 40/279; G06F 16/23; G06N 20/00; G06F 40/253; G06F 40/30

(52) U.S. Cl. CPC G06F 40/279; G06F 16/2379; G06F 40/30; G06N 20/00; G06F 40/253; G06F 16/2365

(57) ABSTRACT

Systems and methods are provided for a computing system. The method of the computing system may detect and resolve circular references in preparation for validating the file. The method may include receiving a request, from a client, to validate a file. The method may further include, detecting, using logic and grammar rules, declarations, definitions, and references of entities in the file and resolving circular references in the file. The resolving includes, determining, as second entities, one or more of the entities that have respective references that lack preceding definitions corresponding to the respective references, and for each second entity of the second entities, prepending a declaration of the second entity before a reference of the second entity to create an updated file.

### BACKGROUND

Circular references in files or scripts occur when entities in a series sequentially reference one another and a last entity in the series references a first entity in a loop. These circular references need to be resolved before the files or scripts undergo a single-pass validation procedure. Otherwise, the files or scripts may not be validated using the single-pass validation procedure prior to deployment.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A is a computing system that processes circular references and validates a file in a single pass, according to embodiments described in the present disclosure.

FIG. 1B is a computing component of the computing system illustrated in FIG. 1A that uses logic and grammar rules to identify circular references.

FIG. 1C shows a further implementation of the computing component shown in of FIG. 1B, and is a computing component of the computing system illustrated in FIG. 1A that uses logic and grammar rules to identify circular references by mapping or associating references to corresponding declarations.

FIG. 1D is a computing component of the computing system illustrated in FIG. 1A that prepends declarations to a file in order to resolve circular references.

FIG. 1E is a computing component of the computing system illustrated in FIG. 1A that generates a table showing which line number or line numbers contain declarations and corresponding definitions and references.

FIG. 1F is a component of the computing system illustrated in FIG. 1A that validates a file after circular references have been removed from the file.

FIG. 1G is a computing component of the computing system illustrated in FIG. 1A that indicates a mapping between line numbers in an updated file and line numbers in an original file.

FIG. 1H is an alternative embodiment of a computing component of the computing system illustrated in FIG. 1A that resolves circular references in a different file from that shown with respect to FIGS. 1B-1G. indicates a mapping between line numbers in an updated file and line numbers in an original file.

FIG. 1I is a computing component of the computing system illustrated in FIG. 1H that illustrates grammar rules and logic used to resolve circular references in the embodiment shown in FIG. 1H.

FIG. 1J is a computing component of the computing system illustrated in FIG. 1H that prepends declarations to a file in order to resolve circular references.

FIG. 2 is an exemplary flowchart illustrating a process of prepending declarations to references that are missing preceding declarations, according to embodiments described in the present disclosure.

FIG. 3 is an exemplary flowchart illustrating a process of prepending declarations to forward referencing entities that are missing preceding declarations, according to embodiments described in the present disclosure.

FIG. 4 is an exemplary flowchart illustrating a process of reordering or removing prepended declarations, according to embodiments described in the present disclosure.

FIG. 5 is an exemplary flowchart illustrating a process of validating a file in which circular references have been resolved, according to embodiments described in the present disclosure.

FIG. 6 is an example computing component that may be used to implement various features of embodiments described in the present disclosure.

The figures are not exhaustive and do not limit the present disclosure to the precise form disclosed.

### DETAILED DESCRIPTION

Files or scripts (hereinafter “files”)may be written in a declarative format, such as Extensible Markup Language (XML), YAML Ain't Markup Language (YAML), JavaScript Object Notation (JSON), Initialization (INI), or HashiCorp Configuration Language (HCL), and prone to circular references. Current approaches of reordering or rearranging the configuration file do not resolve circular references and may detrimentally impact readability. These approaches include, for example, reordering all declarations of entities to occur before any references regardless of types of entities referred to, and splitting context associated with the references on a per-entity basis. However, this approach may break up code that was intended to be organized in a single combined block by separating a declaration that was originally within another declaration into a separate block, which may cause confusion to a reader and sometimes errors when deploying or running the code. Another approach is assuming auto-creation or automatic declaration of any entity that was not declared prior to reference. However, such an approach may run counter to a user's intent, while unnecessarily consuming memory.

In particular, these approaches that handle circular references either do not rectify circular references, require multiple passes to detect the circular references, or introduce potentially invalid assumptions that any forward reference is valid. These circular references, if not addressed, may prevent validation during a single-pass validation process because of an inability of the validation process to resolve the circular references or detect that an entity has been declared after it was referenced. Thus, a technique to handle circular references would improve an effectiveness and efficiency of a single-pass validation process.

As a result, entities (i.e. objects or structs) such as variables, data structures, functions, or methods, may be properly declared before a reference to that entity, while obviating back-and-forth interactions with a user to resolve the circular references. The validation process may then confirm whether the file is syntactically and semantically correct, in only a single pass.

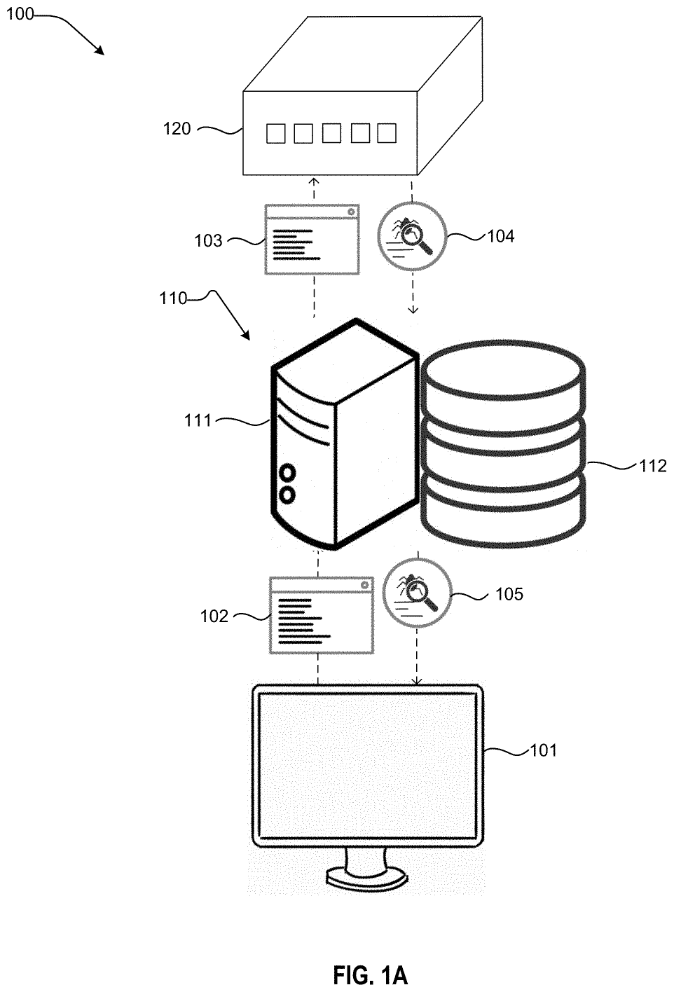

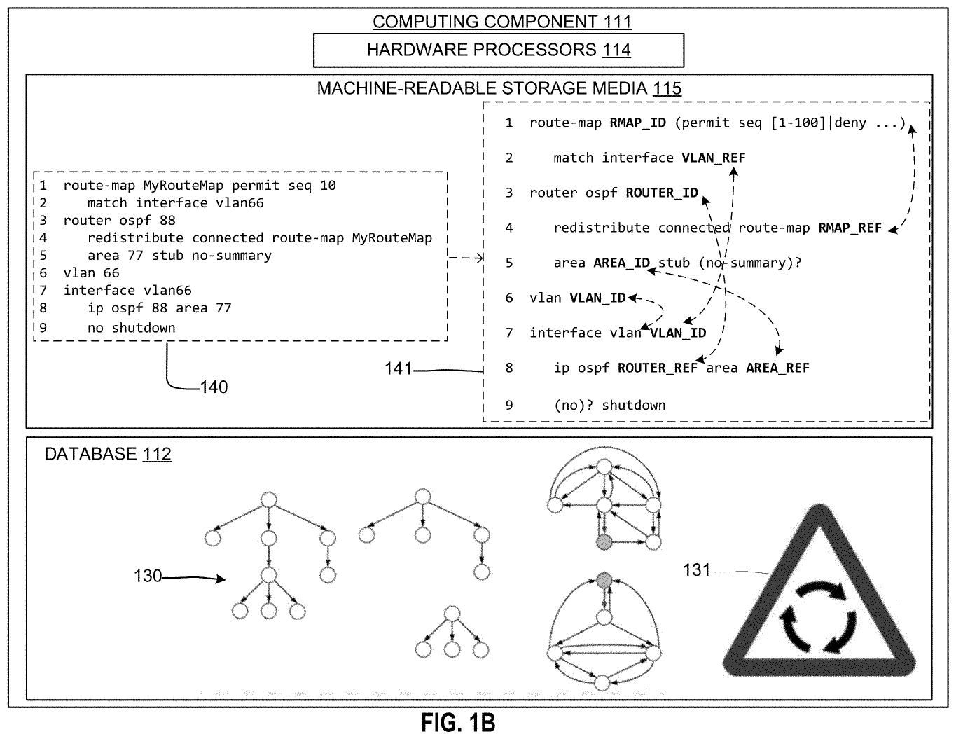

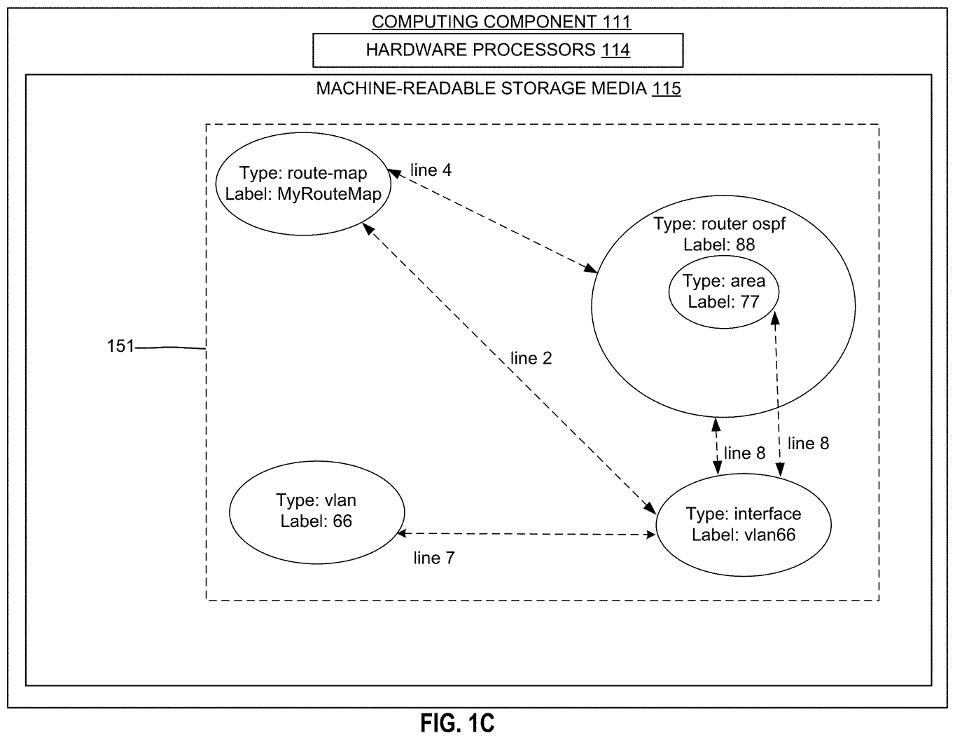

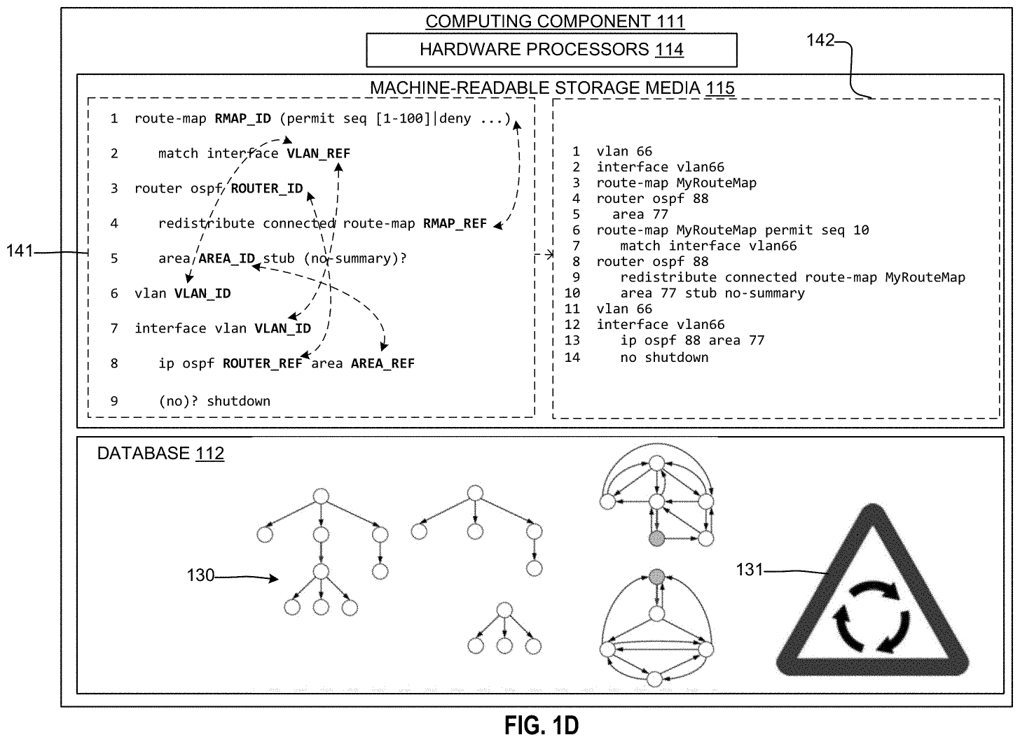

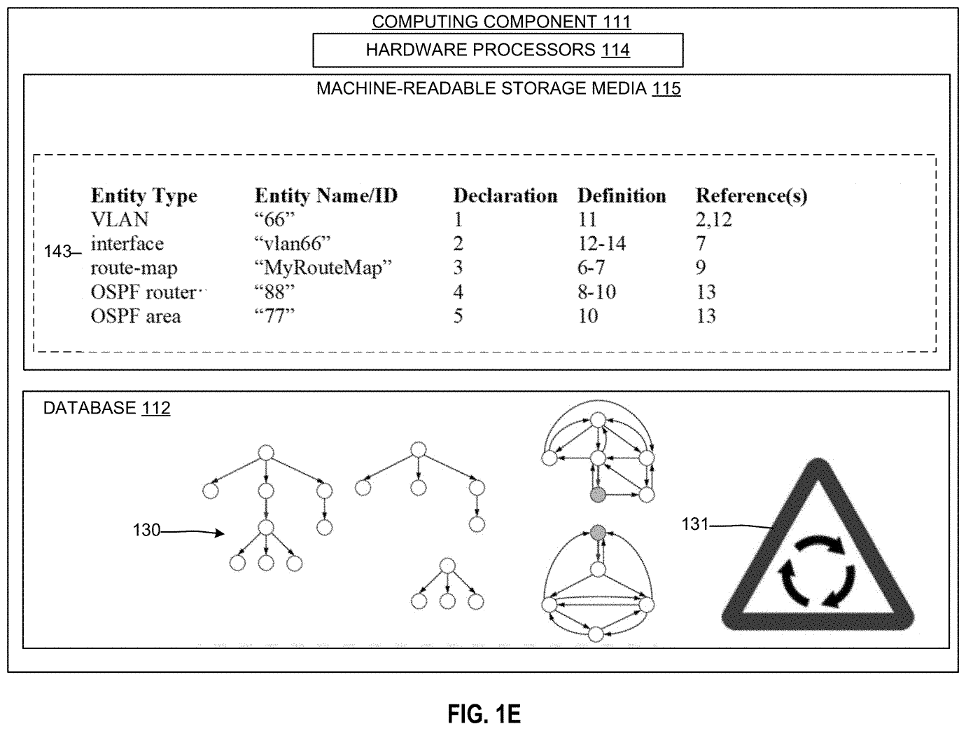

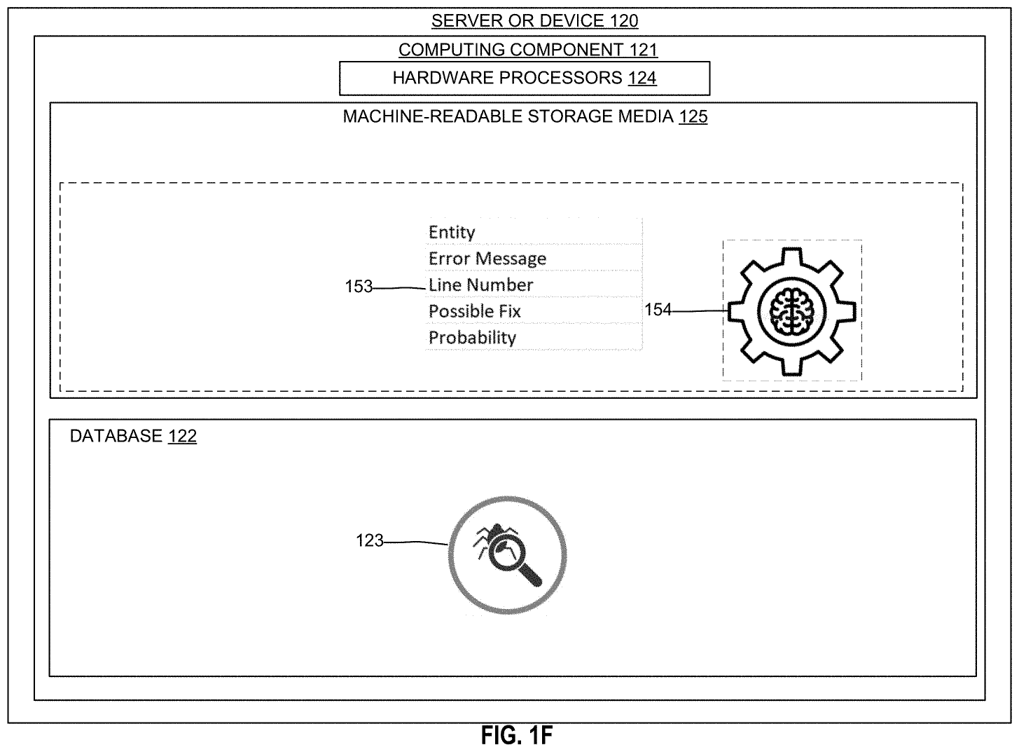

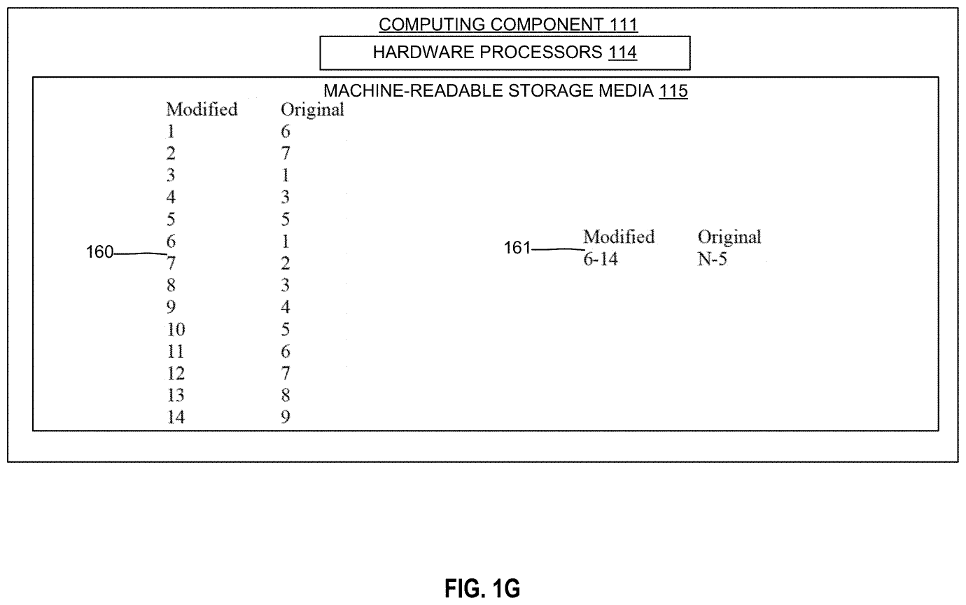

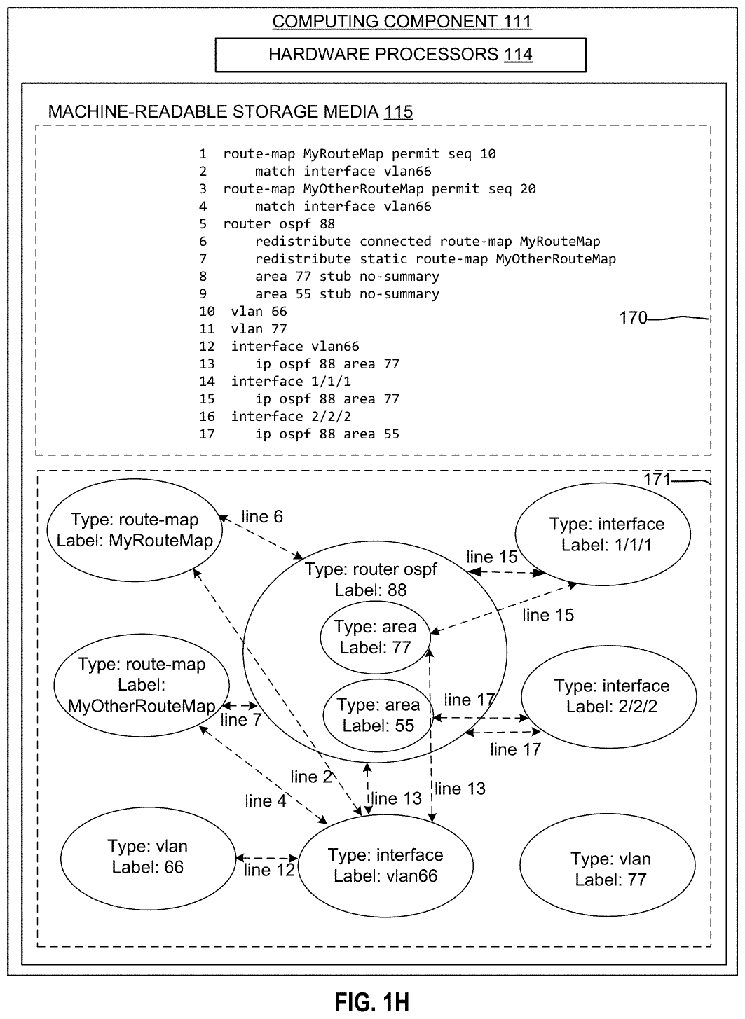

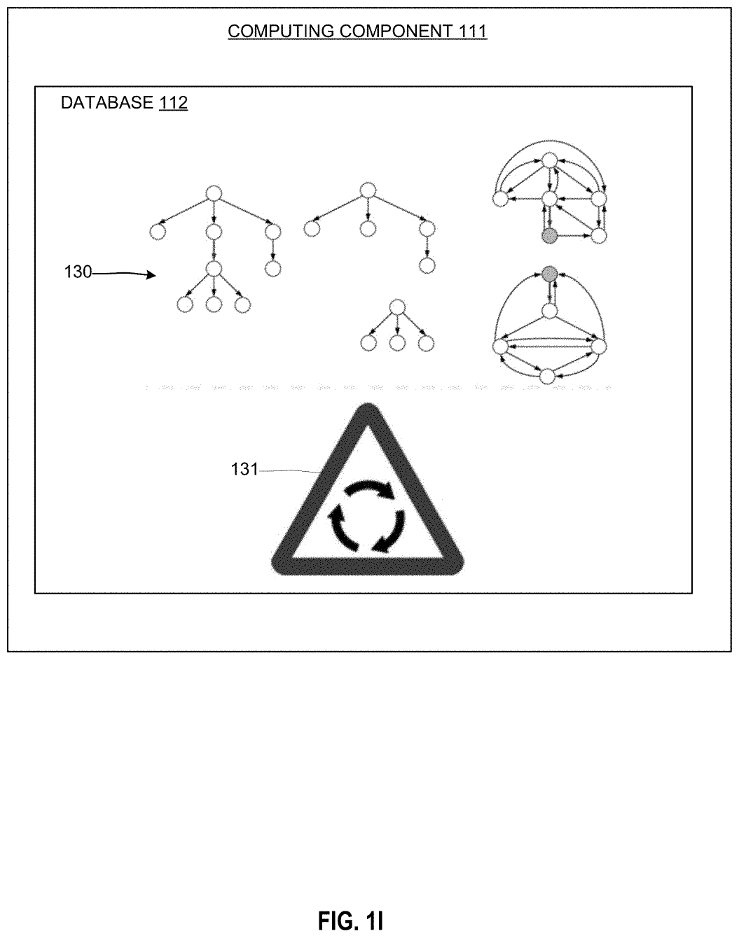

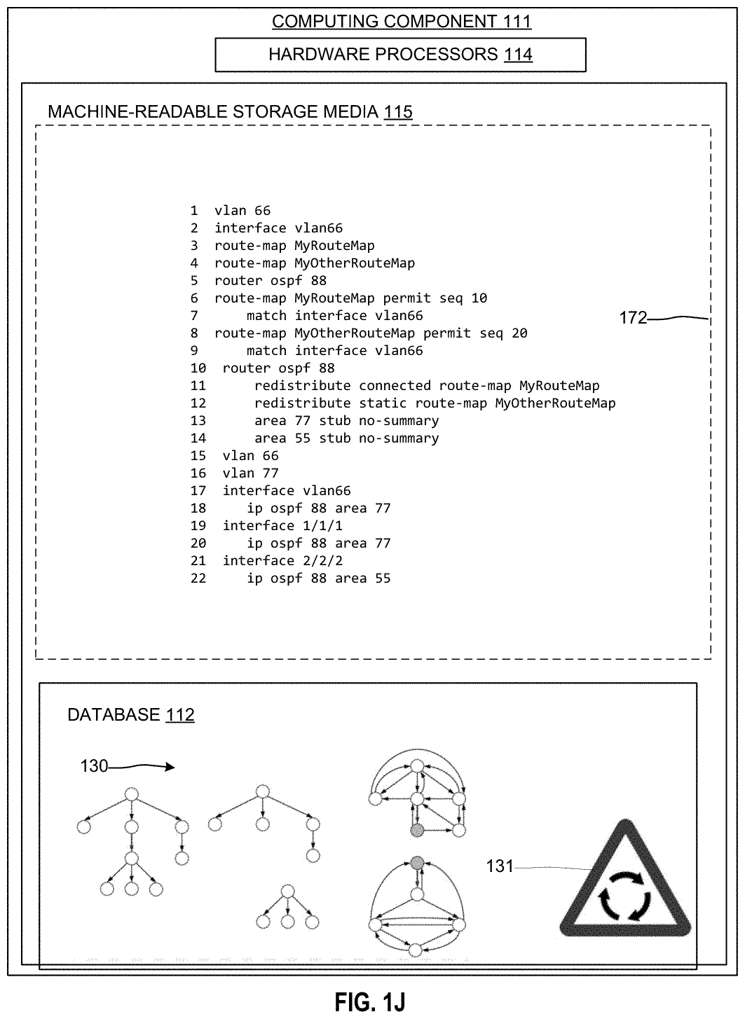

In some embodiments, as shown in FIG. 1A, a computing system 100 that processes circular references and validates a file in a single pass may include a client 101 from which a file 102 is sent to a server 110. FIG. 1A illustrates an overview of the process and further details of the process will be described in subsequent FIGS. In some embodiments, the file 102 may be a configuration file. The server 110 may be, for example, a virtual machine (VM) server, a cloud server, or a physical server. In some embodiments, the server 110 may be either a stand-alone machine or embedded inside another machine. The server 110 may include a computing component 111 that executes a sequence of commands to identify and resolve circular references in the file 102 and a database 112 that includes grammar rules to identify circular references in accordance with any applicable language, such as a domain specific language (DSL), a declarative programming language such as Prolog or structured query language (SQL), or a general-purpose language (GPL), which may include Python, Java, Go, C#, C, C++, JavaScript, Ruby, or Visual Basic. The grammar rules may determine if an entity that is referenced has been properly declared by identifying a reference to that entity, and searching the file to determine whether that entity has been properly declared. The grammar rules may include permitted formats of such a declaration of that entity. The server 110 may identify and resolve circular references in the file 102 and send an updated file 103 having the resolved circular references to a physical or virtual device 120, which may include a server (hereinafter “device or server 120”), that validates the updated file 103. In some embodiments, the server may be an internal pre-processor running within the device or server 120. In some embodiments, the server 110 may act as a transpiler to generate an equivalent script in the updated file 103, such that the updated file 103 would be compatible with the device or server 120, which may not support resolution of circular references. Communication between the server 110 and the device or server 120 may occur by any suitable means, including but not limited to Simple Network Management Protocol (SNMP) and Representational State Transfer (REST) application program interfaces (APIs). In some embodiments, the device or server 120 may be a switch, a server, or any device having a processor that uses configuration files, and which validates configuration files but does not resolve circular references. The device or server 120 may be a client device or a server that transmits files or otherwise provides services to a client device. The device or server 120 may transmit, to the server 110, an indication of whether the updated file 103 is syntactically and semantically valid, and any line numbers in the updated file 103 that do not conform with syntactic and semantic rules of a particular programming language. The server 110 may, in turn, map the line numbers from the device or server 120 to line numbers corresponding to the file 102 (e.g., the original file prior to generation of the updated file 103). The server 110 may transmit, to the client 102, the mapped line numbers.

FIG. 1B illustrates an exemplary operation of the computing component 111 of the server 110. In FIG. 1B, the computing component 111 may one or more hardware processors 114 and machine-readable storage media 115 storing a set of machine-readable/machine-executable instructions that, when executed, cause the hardware processor(s) 114 to identify circular references in a file 140, which may be implemented as the file 102. The computing component 111 also includes a database 112 that includes grammar rules and/or logic (hereinafter “grammar rules”) 130 to identify, in the file 140, declarations of, definitions of, and/or references to entities, and grammar rules 131 to identify when a reference to an entity occurs before any declaration of that entity. The grammar rules 130 detect or identify, in the file 140, where declarations, definitions, and/or references occur, whereas the grammar rules 131 use the declarations, definitions, and/or references from the grammar rules 130 to identify when a reference to an entity lacks a preceding declaration, and thus, that a preceding declaration needs to be prepended. The grammar rules 131 may be comprised within a static or generated grammar file, and/or may be extracted via programmatic exploration of all command variations to determine or infer syntactically legal variations. As alluded to above, the grammar rules 130 and the grammar rules 131 may apply to any applicable language, such as a domain specific language (DSL), a declarative programming language such as Prolog or structured query language (SQL), or a general-purpose language (GPL), which may include Python, Java, Go, C#, C, C++, JavaScript, Ruby, or Visual Basic. In some embodiments, the database 112 may be updated as new programs and/or functions are introduced.

In some examples, the database 112 may include a machine learning model that is trained to incorporate an intent of a user from the client 101. For example, the machine learning model may be trained via feedback from the user of the client 101 and/or feedback received from the device or server 120 in an event of a semantically or syntactically incorrect portion of code in the file 140 that may nonetheless be intended as a definition of, a declaration of, or a reference to an entity that was included elsewhere in the file 140. As a particular example, if the file 140 includes a misspelling of an entity by one letter, such as “rout-map” or “route map” not including a hyphen, or has an extra space in an entity name, the machine learning model may infer that the user may have intended a closely matching entity such as “route-map,” and indicate a probability of such intent. In some examples, the machine learning model may be trained using a dataset that includes previous mistakes specific to the user. By incorporating the machine learning model, the computing component 111 may, based on an assumption of a user-specific intent, avoid an incorrect assumption of a reference to an entity being before or without any declaration of that entity.

In FIG. 1B, the computing component 111 generates an output 141 that bi-directionally associates or maps each declaration of an entity to a reference of that entity to determine contexts associated with each of the references and to identify any forward references. A forward reference occurs when an entity is referred to without a preceding declaration. In such a bi-directional association or mapping, each reference may point to a corresponding declaration, and that declaration may point back to all references corresponding to that declaration. In some examples, as will be shown in FIG. 1H, multiple references may point to a same declaration. Here, in FIG. 1B, line 2 of the output 141 may be a forward reference to line 7 as entities “vlan 66” and “interface vlan66” are referred to without respective preceding declarations. The forward reference of objects “vlan66” and “interface vlan66” causes a circular reference between “route-map MyRouteMap,” “interface vlan66,” and “ospf 88,” because “route-map MyRouteMap” refers to “interface vlan66,” “interface vlan66” refers to “ospf 88,” and “ospf 88” refers back to “route-map MyRouteMap.” Each of the objects may have a type and an identifier. For example, the object “vlan 66” may have a type “vlan” and an identifier “66.” As another example, the object “interface vlan66” may have a type “interface” and identifier “vlan66.” Here, the identifier “vlan66” has no space between “vlan” and 66″ while the object “vlan 66” includes a space between “vlan” and “66” because the computing component 111 may remove the previously existing space between “vlan” and “66” to create a single identifier “vlan66.” As shown in FIG. 1C, the computing component 111 generates an output 151 that specifically illustrates an association or mapping of each reference to a corresponding declaration, without showing the original order of the code as in the output 141.

Other references, “route-map MyRouteMap,” “ip ospf,” and “area 77,” in lines 4 and 8, respectively, include preceding declarations in lines 1, 3, and 5, respectively. The computing component 111 may further identify definitions of an entity, such as, “vlan 66” in line 6, “interface vlan66” in lines 7 to 9, “route-map MyRouteMap” in lines 1 to 2, “ip ospf 88” in lines 3 to 5, and “area 77” in line 5.

In the output 141, the computing component 111 may identify any command that includes a reference to an entity before any corresponding definition of the entity. Entities that have respective references that lack preceding definitions corresponding to the respective references may be referred to as second entities. For example, the computing component 111 may determine “interface vlan66” as a second entity because “interface vlan66” is referenced in line 2 prior to a definition of “interface vlan66” in lines 7-9 of the file 140. The computing component 111 may determine or infer respective contexts associated with the second entities using the grammar rules 130. In some embodiments, the context may include one or more third entities referenced by the second entity and one or more fourth entities that reference the second entity. In this example, third entities referenced by the second entity “interface vlan66” include “vlan 66,” “ip ospf 88,” and “area 77” because “interface vlan66” references “vlan 66.” As explained above, the “vlan66” of “interface vlan66” is a same entity as “vlan 66” which includes a space between the “vlan” and “66.” In addition, “interface vlan66” references “ip ospf 88” and “area 77” in lines 8-9 of the file 140 Fourth entities that reference the second entity include “route-map MyRouteMap” in lines 1-2 of the file 140. The computing component 111 may prepend declarations of the second entity “interface vlan66,” and declarations of the third entities and the fourth entities “vlan 66,” “ip ospf 88,” “area 77,” and “route-map MyRouteMap.” After prepending the declarations, the computing component 111 may order the prepended declarations according to an order of the declarations, or according to an order in which an entity was first referenced, in the file 140. In some examples, the second entity or entities may be ordered before at least some of, or all of, the third entities and the fourth entities. In some examples, the contexts associated with the second entities further include one or more additional entities referenced by other second entities of the second entities, although only one second entity exists in this example.

In other words, the context of a second entity may include a declaration component and a definition component. The declaration component may indicate an existence of the second entity and the definition component may include characteristics associated with the second entity. The characteristics may include one or more third entities referenced by the second entity and one or more fourth entities that reference the second entity. The computing component 111 may prepend the declaration component of the second entity before the definition component of the second entity.

As a result, as shown in FIG. 1D, the computing component 111 may prepend declarations “vlan 66,” “interface vlan66,” “route-map MyRouteMap,” “router ospf 88,” “and “area 77” to lines 1 to 5 in an updated file 142, which may be implemented as the updated file 103 of FIG. 1A. Prepending declarations in the updated file 142 may have analogous effect as an “extern” keyword to declare variables in C programming language. Prepending these declarations may ensure that all entities are declared before being referenced. In some embodiments, the computing component 111 may dynamically determine an order in which the declarations are prepended based on an order in which respective references to the corresponding entities first appear. In some embodiments, the computing component 111 may further remove any declarations which are not referenced prior to their definition, for example, in line 3 of the updated file 142. For example, “route-map My RouteMap” was defined in line 11 of the updated file 142. In particular, “route-map My RouteMap” was prepended to the updated file 142 in line 3. However, the next time “route-map My RouteMap” appears in the updated file 142 is in line 6, as a declaration. “route-map My RouteMap” is not otherwise referenced prior to its declaration in line 6. Thus, “route-map My RouteMap” was not referenced before its declaration in line 6 and may be removed from line 3 without resulting in a circular reference or affecting validation of the updated file 142. The computing component 111 may further remove any duplicate declarations or definitions, which are declarations or definitions that are identical to a prior declaration or definition. As shown in FIG. 1E, the computing component 111 may generate a table 143 illustrating which line number or line numbers contain declarations, definitions, and references to each of the respective entities in the updated file 142. A declaration is a language construct that specifies properties or attributes, such as a type and a name, of an entity, and an existence of that entity. A definition is a language construct that includes details of that entity, including references used by that entity. For example, if the entity is a function, the definition includes what the function does. If the entity is a class, the definition includes fields and methods of the class. If the entity is a variable, the definition includes where that variable is stored. In some examples, a declaration also includes a definition of an entity. A reference to an entity is a command that refers to that entity, for example, as part of a definition of another entity.

After the circular references are resolved by the server 110, the server 110 may transmit the updated file 142 to a device or server 120. Because the updated file 142 rather than the file 140 is transmitted to the device or server 120, the device or server 120 would not get stuck and/or divert resources while attempting to process circular references. In some embodiments, the updated file 142 may be command line interface (CLI) formatted. As shown in FIG. 1F, the device or server 120 may include a computing component 121 that further includes one or more hardware processors 124 and machine-readable storage media 125 storing a set of machine-readable/machine-executable instructions that, when executed, cause the hardware processor(s) 124 to validate a file transmitted from the server 110. The computing component 121 also includes a database 122 that includes rules and/or logic (hereinafter “rules”) 123 to identify syntactic and/or semantic errors other than circular references. Errors may be nonconformities, or interpreted as portions of the updated file 142 that failed validation due to nonconformity with the rules and/or logic 123. Whereas the grammar rules 130 and 131 were used to identify and resolve circular references at the computing component 111, here, the rules 123 are used by the device or server 120 to identify other syntactic and/or semantic errors such as spelling errors after the circular references have been resolved. Here, a device may be a client device and a server may include hardware, firmware, and/or software that provides data or other services to client devices. The rules and/or logic 123 may apply to any applicable language, such as a domain specific language (DSL), a declarative programming language such as Prolog or structured query language (SQL), or a general-purpose language (GPL), which may include Python, Java, Go, C#, C, C++, JavaScript, Ruby, or Visual Basic.

In some embodiments, the database 122 may be updated as new programs and/or functions are introduced. The computing component 121 may, using the rules 123, identity and output, in a log 153, an entity (e.g., object) associated with an error, an error message indicating a nature of the error, a line number of the error, one or more possible fixes to the error, and/or probabilities that the possible fixes would effectively address the error. In some embodiments, the possible fixes and/or the probabilities may be determined by a machine learning model 154. The machine learning model 154 may be trained using a dataset including errors that have historically been encountered by a specific user (e.g., of the client 101) and previous fixes that have historically been deployed to resolved the encountered errors or types of the encountered errors by that specific user. For example, the machine learning model 154 may be trained via feedback from the user of the client 101 in an event of a semantically or syntactically incorrect portion of code in the updated file 142. As a particular example, if the updated file 142 includes a misspelling of an entity by one letter, such as “rout-map” or “route map” not including a hyphen, or has an extra space in an entity name, the machine learning model 154 may infer that the user may have intended to refer to a closely matching entity such as “route-map,” and indicate a probability of such intent. The probability may be determined based on an absolute and relative frequency, relative to other errors, of such an error from that user, and/or a rate in which a fix or type of fix was deployed to address a same type of error that occurred previously.

The computing component 121 may then transmit, to the computing component 111, a subset of data from the log 153. Here, a subset of data may refer to all of or a portion of the data. For example, the computing component 121 may transmit, to the computing component 111, line numbers of the updated file 142 that have failed validation, or in other words, failed to conform to syntactic or semantic requirements. The computing component 111 may include a table 160 indicating a mapping between line numbers in the updated file 142 and line numbers in the file 140, as shown in FIG. 1G. In other words, the mapping may associate line numbers of the file 140 before the prepending of the declarations to line numbers of the updated file 142 that was generated after the prepending of the declarations. Alternatively, the computing component 111 may include a table 161 that summarizes an applicable subset of the table 160 using an offset. The computing component 111 may then convert the line numbers of the updated file 142 that have failed validation to corresponding line numbers of the file 140 using the mapping from the table 160. For example, if the line numbers of the updated file 142 indicated that lines 1 and 2 failed validation, the computing component 111 may then convert the lines 1 and 2 of the updated file 142 to lines 6 and 7 of the file 140, and report, to the client 101, that lines 6 and 7 of the file 140 failed validation. In some embodiments, the computing component 111 may also report, to the client 101, other data from the table 153, including, for example, an entity (e.g., object) associated with an error, an error message indicating a nature of the error, one or more possible fixes to the error, and/or probabilities that the possible fixes would effectively address the error. In some embodiments, the computing component 111 may refrain from transmitting the updated file 142 to the client 101. In such a manner described above, the resolution of circular references by the computing component 111 may allow the computing component 121 to validate a file (e.g., the updated file 142) in only a single pass, without requiring the computing component 121 to support resolution of circular dependencies. The resolution of circular dependencies further avoids automatic declaration of potentially mistyped references and does not compromise readability.

FIG. 1H illustrates an exemplary operation of the computing component 111 of the server 110. In FIG. 1H, the computing component 111 generates an output 171 from an exemplary file 170. In the file 170, lines 2 and 4 illustrate that two different lines from two different contexts, in particular from, “route-map MyRouteMap” and “route-map MyOtherRouteMap,” may refer to a common declaration of “Interface vlan66.” Additionally, lines 13 and 15 also illustrate that two different lines from two different contexts, in particular from, “interface vlan66” and “interface 1/1/1,” may refer to a common declaration of “ip ospf 88 area 77.” Meanwhile, lines 6 and 7 illustrate that multiple references of a common type, “MyRouteMap” and “MyOtherRouteMap,” which both have a type “route-map,” may occur within a context of a single definition, “router ospf 88.” Furthermore, lines 8 and 9 illustrate that multiple declarations can occur within a context of a single definition. In this example, declarations of “area 77” and “area 55” may occur within a context of a definition of “router ospf 88.” Moreover, line 11 illustrates a declaration that exists with no corresponding reference. The computing component 111 may support these aforementioned features of the file 170.

In the output 171, the computing component 111 may identify any command that includes a reference to an entity before any corresponding definition of the entity. Entities that do have respective references that lack preceding definitions corresponding to the respective references may be referred to as second entities. For example, the computing component 111 may determine “interface vlan66” as a second entity because “interface vlan66” is referenced in lines 2 and 4 prior to a definition of “interface vlan66” in 12-13 of the file 170. The computing component 111 may determine or infer respective contexts associated with the second entities using the grammar rules 130 and 131, as shown in FIG. 11, and as described with respect to FIG. 1B. In some embodiments, the context may include one or more third entities referenced by the second entity and one or more fourth entities that the second entity references. In this example, third entities referenced by the second entity “interface vlan66” may include “vlan 66,” and “ip ospf 88” because “interface vlan66” references “ip ospf 88 in line 13. Although “area 77” is also referenced by “interface vlan66,” “area 77” was already previously referenced under a definition of “router ospf 88” in lines 5-8 of the file 170, so “area 77” is already included in the definition of “router ospf 88.” Fourth entities that reference the second entity may include “route-map MyRouteMap” and “route-map MyOtherRouteMap” in lines 1-4 of the file 170. The second entity, the third entities, and the fourth entities may all be prepended to the file 170, as shown in an updated file 172 of FIG. 1J.

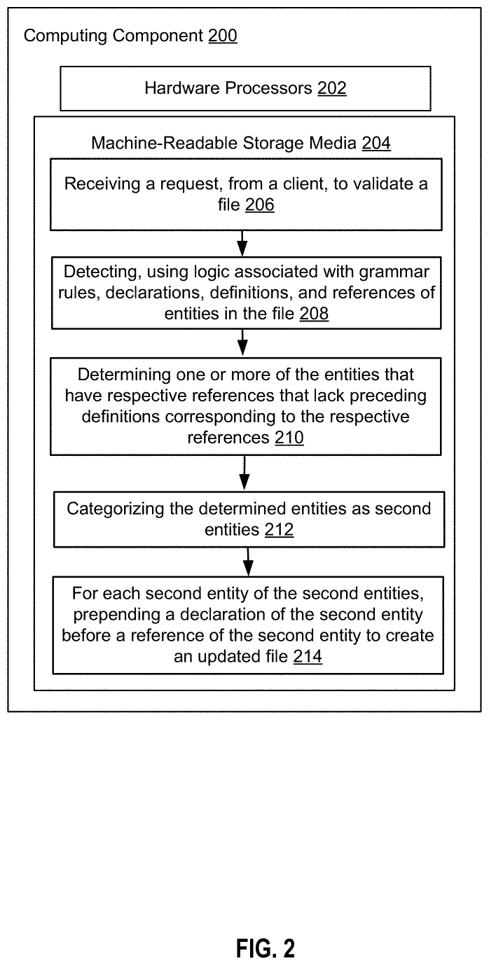

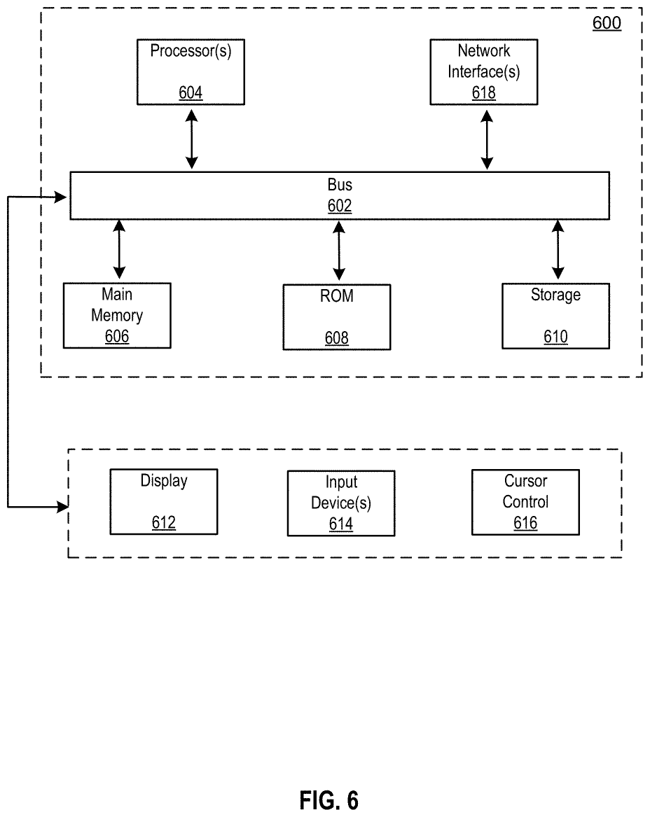

FIG. 2 illustrates a computing component 200 that includes one or more hardware processors 202 and machine-readable storage media 204 storing a set of machine-readable/machine-executable instructions that, when executed, cause the hardware processor(s) 202 to resolve circular references in a file. The computing component 200 may be implemented as the computing component 111 of FIGS. 1A-1E and 1G-1J. The machine-readable storage media 204 may include suitable machine-readable storage media described in FIG. 6 and may be implemented as the machine-readable storage media 115 and/or 125 from FIGS. 1A-1E and 1G-1J and/or FIG. 1F. It should be appreciated that there can be additional, fewer, or alternative steps performed in similar or alternative orders, or in parallel, within the scope of the various embodiments discussed herein unless otherwise stated.

At step 206, the hardware processor(s) 202 may execute machine-readable/machine-executable instructions stored in the machine-readable storage media 204 to receive, from a client such as the client 101 of FIG. 1A, a request to resolve circular references and/or validate a file. At step 208, the hardware processor(s) 202 may execute machine-readable/machine-executable instructions stored in the machine-readable storage media 204 to detect, using logic and grammar rules, declarations, definitions, and references of entities in the file. At steps 210, 212, and 214, the hardware processor(s) 202 may execute machine-readable/machine-executable instructions stored in the machine-readable storage media 204 to resolve circular references in the file. The resolving of circular references may entail, in step 210, determining one or more of the entities that have respective references that lack preceding definitions corresponding to the respective references. In step 212, the hardware processor(s) 204 may categorize the determined entities as second entities. Thus, entities that have been referenced but not defined before they were referenced would be categorized as second entities. In step 214, the hardware processor(s) 204 may, for each second entity of the second entities, prepend a declaration of the second entity before a reference of the second entity to create an updated file. Entities may include, but are not limited to, objects such as variables, data structures, functions, or methods.

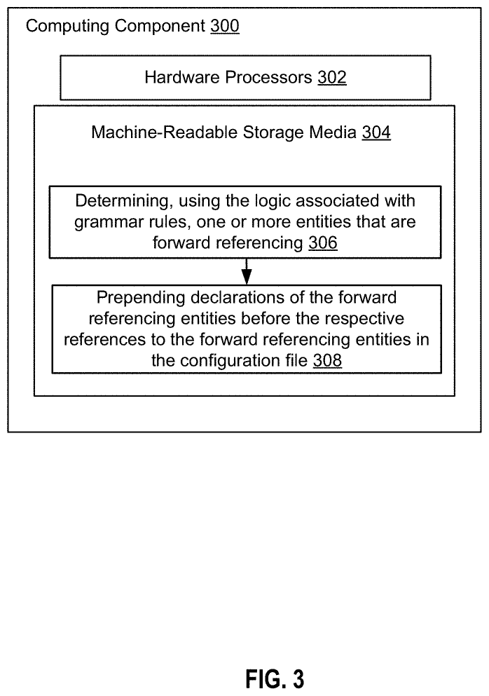

FIG. 3 illustrates a computing component 300 that includes one or more hardware processors 302 and machine-readable storage media 304 storing a set of machine-readable/machine-executable instructions that, when executed, cause the hardware processor(s) 302 to resolve circular references in a file. The computing component 300 may be implemented as the computing component 111 of FIGS. 1A-1E and 1G-1J. The machine-readable storage media 304 may include suitable machine-readable storage media described in FIG. 6 and may be implemented as the machine-readable storage media 115 and/or 125 from FIGS. 1A-1E and 1G-1J and/or FIG. 1F. It should be appreciated that there can be additional, fewer, or alternative steps performed in similar or alternative orders, or in parallel, within the scope of the various embodiments discussed herein unless otherwise stated.

At step 306, the hardware processor(s) 302 may execute machine-readable/machine-executable instructions stored in the machine-readable storage media 304 to determine, using logic and grammar rules, one or more entities in a file, such as a configuration file, that are forward referencing, which may mean, for example, that an entity has been referenced without a preceding declaration. The logic and the grammar rules may detect declarations, definitions, and references of entities in a configuration file and detect one or more forward references in which a reference to an entity lacks a preceding definition corresponding to the reference in the configuration file. At step 308, the hardware processor(s) 302 may execute machine-readable/machine-executable instructions stored in the machine-readable storage media 304 to prepend declarations of the forward referencing entities before the respective references to the forward referencing entities in the configuration file.

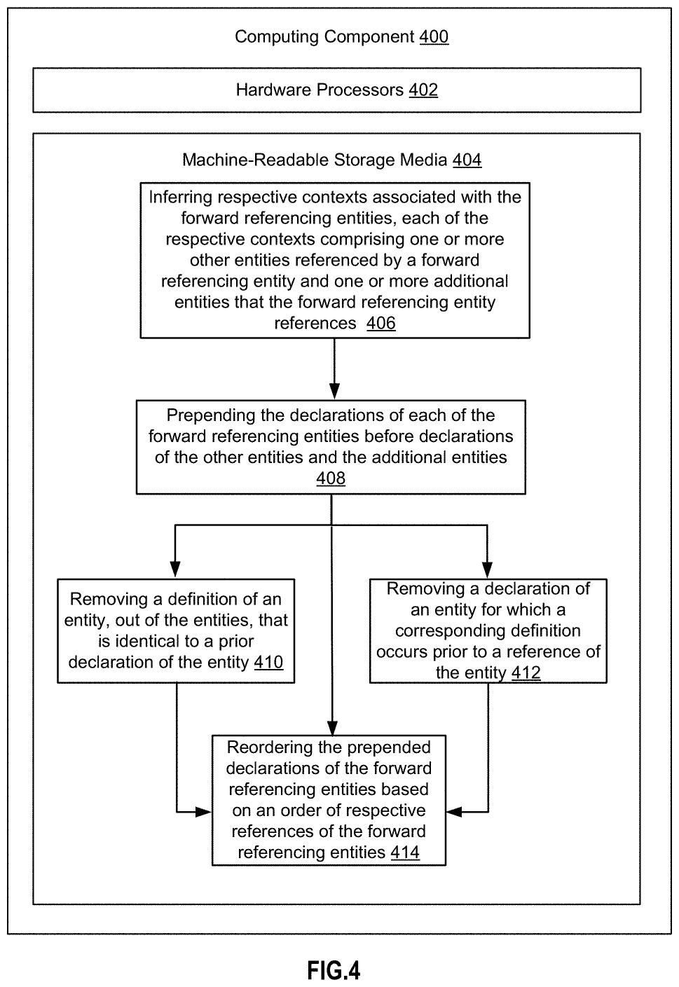

FIG. 4 illustrates a computing component 400 that includes one or more hardware processors 402 and machine-readable storage media 404 storing a set of machine-readable/machine-executable instructions that, when executed, cause the hardware processor(s) 402 to resolve circular references in a file. The computing component 400 may be implemented as the computing component 111 of FIGS. 1A-1E and 1G-1J. The machine-readable storage media 404 may include suitable machine-readable storage media described in FIG. 6 and may be implemented as the machine-readable storage media 115 and/or 125 from FIGS. 1A-1E and 1G-1J and/or FIG. 1F. It should be appreciated that there can be additional, fewer, or alternative steps performed in similar or alternative orders, or in parallel, within the scope of the various embodiments discussed herein unless otherwise stated. Steps illustrated in FIG. 4 elucidate and expand upon the step 308 as described in FIG. 3.

At step 406, the hardware processor(s) 402 may execute machine-readable/machine-executable instructions stored in the machine-readable storage media 404 to infer respective contexts associated with the forward referencing entities. Each of the respective contexts may include one or more other entities referenced by a forward referencing entity and one or more additional entities that the forward referencing entity references. At step 408, the hardware processor(s) 402 may execute machine-readable/machine-executable instructions stored in the machine-readable storage media 404 to prepend the declarations of each of the forward referencing entities before declarations of the other entities and the additional entities. Following step 408, the hardware processor(s) 402 may execute any one or more of steps 410, 412, and 414. In step 410, the hardware processor(s) 402 may remove a definition of an entity, out of the entities, that is identical to a prior declaration of the entity. In step 412, the hardware processor(s) 402 may remove a declaration of an entity for which a corresponding definition occurs prior to a reference of the entity. In step 414, following either step 408, 410, or 412, the hardware processor(s) 402 may reorder the prepended declarations of the forward referencing entities based on an order of respective references of the forward referencing entities.

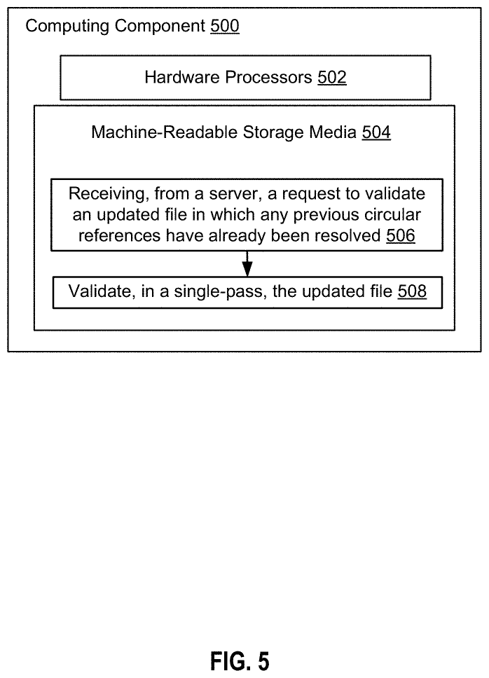

FIG. 5 illustrates a computing component 500 that includes one or more hardware processors 502 and machine-readable storage media 504 storing a set of machine-readable/machine-executable instructions that, when executed, cause the hardware processor(s) 502 to resolve circular references in a file. The computing component 500 may be implemented as the computing component 121 of FIG. 1F. The machine-readable storage media 504 may include suitable machine-readable storage media described in FIG. 6 and may be implemented as the machine-readable storage media 115 and/or 125 from FIGS. 1A-1E and 1G-1J and/or 1F. It should be appreciated that there can be additional, fewer, or alternative steps performed in similar or alternative orders, or in parallel, within the scope of the various embodiments discussed herein unless otherwise stated. FIG. 5 relates to a device that receives an updated file outputted from a server as described with respect to FIGS. 1A-1D, 1F, and 2-4.

At step 506, the hardware processor(s) 502 may execute machine-readable/machine-executable instructions stored in the machine-readable storage media 504 to receive, from a server, such as the server 110 of FIG. 1A, a request to validate a file that has been updated by the server 110 to resolve any circular references within the file. The updated file may be implemented as the updated file 142 of FIG. 1D or the updated file 172 of FIG. 1J. The device, which may be implemented, for example, as the device or server 120 of FIGS. 1A and 1F, that performs the functions illustrated in FIG. 5 may not support resolution of circular references. At step 508, the hardware processor(s) 502 may execute machine-readable/machine-executable instructions stored in the machine-readable storage media 504 to validate the updated file received from the server in a single pass. The validation process may include determining whether one or more portions of the updated file contain a nonconformity with syntactical and semantic rules according to a programming language.

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “engine,” “database,” data store,” and the like, as used herein, can refer to logic embodied in hardware or firmware, or to a collection of software instructions, possibly having entry and exit points, written in a programming language, such as, for example, Python, Java, Go, C#, C, C++, JavaScript, Ruby, or Visual Basic. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method of a computing system comprising:
using logic and grammar rules to detect where definitions and references of entities occur in a file; and
resolving circular references in the file, the resolving comprising:
determining one or more of the entities that have respective references that lack definitions occurring prior to the respective references;
categorizing the determined entities as second entities; and
for the second entities, prepending declarations of the second entities before respective references of the second entities to create an updated file.

2. The computer-implemented method of claim 1, wherein the prepending of the declaration of the second entity before the reference of the second entity comprises:
inferring a context associated with the second entity, the context comprising one or more third entities referenced by the second entity and one or more fourth entities that reference the second entity; and
prepending the declaration of the second entity before declarations of the third entities and the fourth entities.

3. The computer-implemented method of claim 1, wherein the prepending of the declaration of the second entity before the reference of the second entity comprises:
inferring a context associated with the second entity, the context comprising a declaration component and a definition component, wherein:
the declaration component indicates an existence of the second entity and the definition component comprises characteristics associated with the second entity, the characteristics comprising one or more third entities referenced by the second entity and one or more fourth entities that the second entity references; and
prepending the declaration component of the second entity before the definition component of the second entity.

4. The computer-implemented method of claim 2, comprising:
in response to resolving the circular references, removing a duplicate declaration or a duplicate definition of an entity, out of the entities; and
transmitting the updated file to a device that validates the updated file.

5. The computer-implemented method of claim 2, comprising:
in response to resolving the circular references, removing a declaration of an entity for which a corresponding definition occurs prior to a reference of the entity.

6. The computer-implemented method of claim 2, comprising:
in response to resolving the circular references, reordering prepended declarations of the second entities based on an order of respective references of the second entities.

7. The computer-implemented method of claim 2, comprising:
transmitting the updated file to a device or a server that validates the updated file; and
in response to the transmitting of the updated file, receiving, from the device or the server, any of:
an entity associated with an error;
an error message indicating a nature of the error;
a line number, corresponding to the updated file, of the error;
one or more possible fixes to the error; and
probabilities that the possible fixes would effectively address the error, wherein:
the error comprises a syntactical or a semantic nonconformity according to a programming language; and
the probabilities are determined by a machine learning model trained at least in part based on an intent of a user requesting the validation.

8. The computer-implemented method of claim 7, further comprising:
receiving the line number, corresponding to the updated file, of the error;
in response to receiving the line number of the error, converting the received line number of the error to a line number that corresponds to the file; and
transmitting the line number to a client that transmitted the file to the server.

9. The computer-implemented method of claim 2, wherein the context associated with the second entity further comprises one or more additional entities referenced by other second entities of the second entities; and
prepending respective declarations of the additional entities and the other second entities to the file.

10. The computer-implemented method of claim 1, wherein the file comprises a server configuration file or a switch configuration file.

11. A computing system that detects and resolves circular references, the computing system comprising:
a database storing logic and grammar rules to:
detect declarations and references of entities in a configuration file; and
detect one or more forward references to an entity in the configuration file;
one or more processors; and
a memory storing instructions that, when executed by the one or more processors, cause the one or more processors to:
determine, using the logic and the grammar rules, one or more entities that are forward referencing; and
prepend declarations of the forward referencing entities before the respective references to the forward referencing entities in the configuration file.

12. The computing system of claim 11, wherein, during the prepending of the declarations of the forward referencing entities, the instructions cause the one or more processors to:
infer respective contexts associated with the forward referencing entities, each of the respective contexts comprising one or more other entities referenced by a forward referencing entity and one or more additional entities that reference the forward referencing entity; and
prepending the declarations of each of the forward referencing entities before declarations of the other entities and the additional entities.

13. The computing system of claim 12, wherein the instructions further cause the one or more processors to:
in response to prepending the declarations of each of the forward referencing entities before the declarations of the other entities and the additional entities, remove a definition or a declaration of an entity, out of the entities, that is identical to a prior declaration of the entity.

14. The computing system of claim 12, wherein the instructions cause the one or more processors to:
in response to prepending the declarations of each of the forward referencing entities before the declarations of the other entities and the additional entities, remove a declaration of an entity for which a corresponding definition occurs prior to a reference of the entity.

15. The computing system of claim 12, wherein the instructions cause the one or more processors to:
in response to prepending the declarations of each of the forward referencing entities before the declarations of the other entities and the additional entities, reordering the prepended declarations of the forward referencing entities based on an order of respective references of the forward referencing entities.

16. The computing system of claim 12, wherein the instructions further cause the one or more processors to perform:
in response to prepending the declarations of each of the forward referencing entities before the declarations of the other entities and the additional entities, mapping line numbers of the file before the prepending of the declarations to line numbers of an updated file after the prepending of the declarations.

17. A computer-implemented method of a device or server, comprising:
receiving, from a computing system, a request to validate an updated file in which any previous circular references have already been resolved; and
validating, in a single-pass, the updated file to determine whether one or more portions of the updated file contain a nonconformity with syntactical and semantic rules according to a programming language.

18. The computer-implemented method of claim 17, wherein the validating of the updated file further comprises determining data associated with the nonconformity, the data comprising:
an entity associated with the nonconformity;
an message indicating a nature of the nonconformity;
a line number, corresponding to the updated file, of the nonconformity;
one or more possible fixes to the nonconformity; and
probabilities that the possible fixes would effectively address the nonconformity.

19. The computer-implemented method of claim 18, wherein the determining of the one or more possible fixes to the nonconformity and the probabilities that the possible fixes would effectively address the nonconformity is by a machine learning model trained at least in part based on previous nonconformities and fixes addressing the previous nonconformities that are user-specific.

20. The computer-implemented method of claim 17, wherein the device or the server is unable to resolve circular references; and the method further comprises:
transmitting the data to the computing system.
